(19) United States
(12) Patent Application Publication
(10) Pub. No.: US 2007/0198643 A1
(43) Pub. Date: Aug. 23, 2007

(54) ADDRESS RETRIEVAL SYSTEM AND METHOD

(76) Inventor: Ronald S. Cope, Lincolnwood, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/677,102

(22) Filed: Feb. 21, 2007

Related U.S. Application Data
(60) Provisional application No. 60/775,367, filed on Feb. 21, 2006.

(51) Int. Cl. G06F 15/16

(52) U.S. Cl. 709/206

(57) ABSTRACT

Methods and systems for obtaining an email address. One method includes automatically compiling email address information and corresponding identifying information for a plurality of well-known entities from at least one data source; creating an address subsystem including an address database based on the email address information and the corresponding identifying information; providing a user interface, via an email application, the user interface including an address line and a message input mechanism for entering an email message; receiving addressee information from a user via the user interface, the addressee information not including an email address; generating a query based on the addressee information; sending the query to an address subsystem over at least one computer network; receiving at least one match from the address subsystem, the at least one match including an email address; and automatically entering the email address into the address line of the user interface.

### RELATED APPLICATIONS

The present application claims priority to U.S. Provisional Application No. 60/775,367, filed on Feb. 21, 2006, the entire contents of which are herein incorporated by reference.

### BACKGROUND OF THE INVENTION

Electronic mail (“email”) systems do not include a comprehensive directory of email addresses for the users of the system. Thus, for a user to send an email message to an entity (including individuals and groups of individuals) for which the user does not know the email address of the entity, the user generally needs to obtain the address from the entity (also referred to as “the addressee”). Obtaining an address from an addressee may be relatively easy if the user knows the addressee or has another way of contacting the addressee, such as in person or via telephone or mail. If the addressee, however, is a “famous” or well-known entity, such as a well-known writer or a politician, the user may not have another way of contacting the addressee. For example, if a user is composing an email message for Roger Ebert, the well-known columnist for the Sun Times, the user may not know Roger Ebert personally or may not know Roger Ebert's telephone number or mailing address and, therefore, may not have a way of requesting an email address from Roger Ebert.

In these situations, the user may attempt to find the email address of the addressee via a search engine and/or an email address directory. For example, a user may use a search engine and/or an email address directory accessible through the Internet or another network to search for an email address. Search engines include computer-readable software that searches web pages and other resources available over a computer network, such as the Internet, for keywords specified by the user. In some embodiments, a search engine resides on a server connected to the Internet, and a user accesses the search engine via a browser application. A browser application is generally installed and executed by a computing device operated by a user and includes computer-readable software that can access resources available on the Internet (or other networks), such as hypertext or other electronic data. A user can also use a browser application to access an email address directory. Email address directories generally function similar to search engines, but often search only one or more directories of email addresses (e.g., databases), rather than all available resources (e.g., web pages) accessible over a network, such as the Internet, which may or many not include email addresses.

To find an email address of an addressee using the Internet, the user can enter the name of the addressee and/or other information related to the addressee into a search engine and/or an email address directory via a browser application. The search engine and/or the email address directory uses the entered information to search available resources (e.g., available web pages on the Internet or available email directories) for relevant matches (e.g., web pages and/or directory entries) and returns the matches (sometimes referred to as “hits”) to the browser application. The matches returned to the browser application include the resources (e.g., web pages and/or directory entries) deemed by the search engine and/or the email address directory to relate to the information entered by the user. If the search engine and/or the email address directory searches a large number of resources and/or data, the matches returned to the browser application may include an extremely long list of matches, and, in many cases, may not include the email address that the user is searching for. In other cases, the email address that the user is searching for may be included in the list of matches returned to the browser application but may be buried somewhere in the list among thousands, possibly millions of irrelevant matches.

To compose, address, and send an email message, a user generally uses an email application. Some email applications are dedicated-use applications, whose main or primary function generally involves managing email messages. For example, Microsoft® Outlook® and Lotus® Notes® can generally be considered dedicated-use email applications. Generally, dedicated-use applications are stored and executed by the computing device operated by a user.

Other email applications, however, are multiple or general-purpose use applications, which can manage email messages and also perform other functions. For example, a browser application can be considered an email application. Using a general-purpose browser application, a user can access a web page that the user can use to compose, address, and send email messages. Yahoo!, Gmail, and Hotmail are examples of email systems that allow a user to use a general-purpose browser application to manage email messages.

Regardless of whether the email application operated by a user is a dedicated-use application or is a general-purpose application, the user must use multiple resources (e.g., multiple applications and/or multiple web pages) to obtain an email address and use the email address to send an email message. For example, if the email application operated by a user is a dedicated-use application, the user must switch applications and use a browser application to access a search engine and/or an email address directory in order to search for an email address. Once the user finds the email address using the browser application, the user must copy and/or enter the email address into the proper field of the email application.

Similarly, if the email application operated by a user is a general-purpose application, such as a browser application, the user must (1) direct the browser application to a web page for composing, addressing, and sending email message (e.g., an “email web page”) and (2) must direct the browser application or another browser application (e.g., another instance of the browser application) to a web page of a search engine and/or an email address directory (e.g., a “search web page”) in order to search for an email address. Once the user finds the email address using the search web page, the user must still copy and/or enter the email address from the search web page to the proper field of the email web page. Therefore, even if a user operates a general-purpose email application that can access both an email web page and a search web page, information from the search web page is not automatically fed to the email web page.

### SUMMARY OF THE INVENTION

Embodiments of the invention provide an address retrieval system that enables a user to search for and receive an email address of a specified entity and send an email message to the entity from within a single application (e.g., an email application). Thus, the user does not need to switch from one application or web page to another application or web page in order to search for an email address of an addressee. In some embodiments, the address retrieval system includes a specialized database of email addresses that includes email addresses associated with well-known entities, which can improve a user's chance of finding a match when searching for an email address associated with a particular well-known entity. In addition, the address retrieval system eliminates the need for a user to copy and/or enter a match from the one application or web-page to the email application because a match is automatically entered into the address line of an email message being composed by a user.

For example, some embodiments of the invention provide methods of obtaining an email address. One method includes automatically compiling email address information and corresponding identifying information for a plurality of well-known entities from at least one data source and creating an address subsystem including an address database based on the email address information and the corresponding identifying information. The method also includes providing a user interface via an email application. The user interface includes an address line and a message input mechanism for entering an email message. The method further includes receiving addressee information from a user via the user interface, the addressee information not including an email address; generating a query based on the addressee information; sending the query to an address subsystem over at least one computer network; receiving at least one match from the address subsystem, the at least one match including an email address; and automatically entering the email address into the address line of the user interface.

Additional embodiments of the invention provide systems for obtaining an email address. One system includes an address database, an email application, a query interface, and an address subsystem. The address database is configured to store email address information and corresponding identifying information for a plurality of well-known entities. The email application is configured to generate a user interface including an address line and a message input mechanism for entering an email message. The query interface is configured to obtain addressee information entered by the user via the user interface (which does not include an email address), to generate a query based on the addressee information, and to transmit the query to the address subsystem over at least one communication link. The address subsystem is configured to receive the query, to search the address database based on the query, and to transmit at least one match including an email address to the query interface. The email application is further configured to automatically include the email address in the address line of the user interface.

Embodiments of the invention also provide computer-readable mediums encoded with a plurality of processor-executable instructions for obtaining an email address. The instructions can include providing a user interface including an address line and a message input mechanism for entering an email message, the address line including a recipient address field and an addressee information field; receiving addressee information from a user via the addressee information field, the addressee information not including an email address; generating a query based on the addressee information; sending the query to an address subsystem over at least one communication link; receiving at least one match from the address subsystem, the at least one match including an email address; and automatically entering the email address into the recipient address field.

### BRIEF DESCRIPTION OF THE DRAWINGS

In the drawings:

FIG. 1 schematically illustrates an address retrieval system implemented in a networked environment according to one embodiment of the invention.

FIGS. 2-4 illustrate a user interface provided by an email application according to one embodiment of the invention.

FIG. 5 illustrates a method of retrieving an email address according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

In particular, it should be understood that some embodiments of the invention are implemented using various hardware and/or software based computing devices, such as personal or home computers, servers, and other devices that have processors or that are capable of executing applications or sets of instructions. In general, some embodiments may be implemented using existing hardware or hardware that could be readily created by those of ordinary skill in the art. Thus, the architecture of exemplary devices will not be explained in detail, except to note that the devices will generally have a processor, memory (of some kind), and input and/or output mechanisms. In some cases, the devices may also have one or more operating systems and one or more applications that are managed by the operating systems.

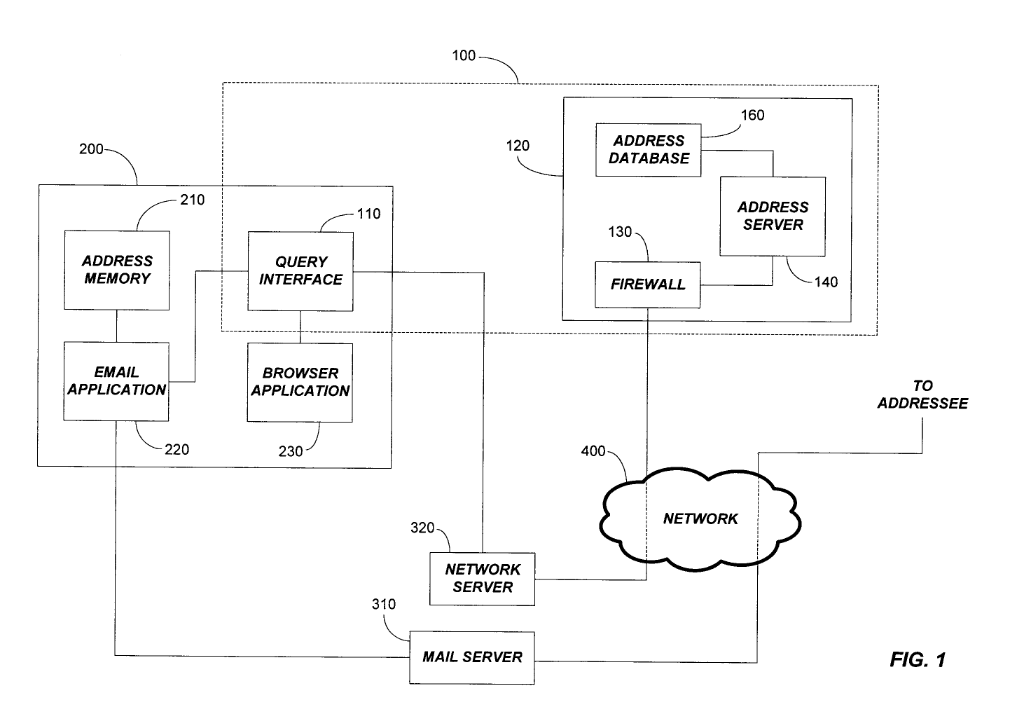

FIG. 1 illustrates an address retrieval system (“system”) 100 implemented in a networked environment according to one embodiment of the invention. As shown in FIG. 1, the system 100 includes an address subsystem 120 and a query interface 110. The query interface 110 can be executed by a computing device 200 external to the address subsystem 120 and can be connected to the address subsystem 120 via a network 400. The network 400 can include one or more networks or communication links and systems, such as a private network (e.g., an intranet), a public network (e.g., the Internet), a telephone system, a wireless network, a satellite network, a cable TV network, and various other private and public networks and systems in various combinations in order to provide the communication links desired or needed to create embodiments or implementations of the invention, as would be apparent to one of ordinary skill in the art. One or more intermediate device or systems, such as network servers 320, routers, bridges, etc., can also be included in the network 400. Thus, embodiments of the invention are not limited to any specific network or combinations of networks or communication links. It should also be understood that in some embodiments, rather than being connected over a network, the query interface 110 can be directly connected to the address subsystem 120 via one or more wired and/or wireless communication links.

As shown in FIG. 1, the address subsystem 120 includes an address database 160 and an address server 140. The address database 160 stores email addresses and corresponding identifying information (e.g., an addressee's name, title or occupation, mailing address, etc.) associated with a group of entities (e.g., people, groups of people, organizations, departments, etc.). The address server 140 queries or searches the address database 160 for a particular email address based on addressee information received from a user. It should be understood that the address database 160 can include one or more memory devices, such as databases, disk drives, etc. It should also be understood that the functionality of the address server 140 and the address database 160 can be combined and provided by a single device or can be distributed among additional devices, systems, etc.

In some embodiments, the address database 160 stores email addresses and corresponding identifying information for a specialized group of entities. For example, the address database 160 can store email addresses associated with actors, writers, politicians, and/or other well-known or famous entities. By restricting the email address information stored in the address database 160 to email address of well-known entities, commonly sought email addresses are not buried among thousands of “non-famous” entries that, generally, as less sought after. For example, as noted above, if an individual is searching for the email address of Roger Ebert, the well-known columnist for the Sun Times, using a standard search engine or email address directory, the individual may have to sort through hundreds or thousands of hits in order to find information related to Roger Ebert, the columnist, among information related to other entities also named or associated with the name “Roger Ebert.” If the address database 160, however, is only loaded with email addresses related to well-known or public entities, hits returned from the address database 160 will generally be fewer (e.g., a single hit) and more relevant. Therefore, the address database 160 can minimize the time and effort required by a user to obtain an email address of a well-known or public entity.

It should be understood that the address subsystem 120 can include or can be configured to access data sources internal to the address subsystem 120 and/or external to the address subsystem 120 (e.g., web pages, external email address directories services, etc.), which the address server 140 can query in order to compile email address information and/or corresponding identifying information. The data sources can include web pages, email address directories, etc., and, in some embodiments, a retrieval application (e.g., a search engine or a web crawler) can be used to locate email address directories for well-known entities that are published and accessible via the Internet. For example, the retrieval application can access an email directory of politicians (e.g., provided through a website of the House of Representatives, the U.S. Senate, etc.) in order to compile information for the address database 160. It should be understood that information can be complied from electronic data sources as well as from paper-based data sources, which can be manually entered in the system and/or converted to an electronic format.

Information received from the data sources can be formatted based on the architecture of the address database 160 and stored to the address database 160. In some embodiments, data sources can be repeatedly searched based on a predetermined schedule and/or upon a manual command in order to find new and/or modified email addresses. For example, the retrieval application can be configured to access an email directory published by the House of Representatives on a regular schedule in order to update email address information related to state representatives. The retrieval application can also be configured to randomly search data sources for email directories meeting certain requirements. It should be understood that the retrieval application can be executed by the address server 140 or a separate computing device internal or external to the address subsystem 120.

The query interface 110 submits queries to the address server 140 via the network 400, and the address server 140 searches the database 160 based on the submitted queries. In some embodiments, the address server 140 includes one or more memory devices and processors. The memory devices can store one or more applications, and the processors can retrieve the applications from the memory devices and execute the applications in order to perform various functions. For example, the memory devices can store applications that include computer-readable software or other digital instructions that, when executed by the processors of the address server 140, communicate with the network 400, interpret queries received from the query interface 110, search the address database 160 according to received queries, and/or communicate matches and/or other information to the query interface 110. As shown in FIG. 1, in some embodiments, the address subsystem 120 also includes a security application or device, such as a firewall 130, to protect the address subsystem 120 from undesirable communications.

The query interface 110 is configured to communicate with one or more external systems and/or devices, such as the address subsystem 120. In some embodiments, the query interface 110 is configured to communicate with any available device connected to the network 400. For example, the query interface 110 can be configured to communicate information between a browser application executed by the computing device 200 and one or more servers or other devices connected to the computing device 200 over the network 400. In other embodiments, the query interface 110 is configured to only communicate with the address subsystem 120.

The computing device 200 can include a personal computer (“PC”), such as a desktop computer or a laptop computer; a personal digital assistant (“PDA”); or another device operable to process digital information and communicate digital information to an external device. The computing device 200 can include a one or more processors and one or more memory devices (not shown). In some embodiments, the memory devices of the computing device 200 can store one or more applications that the processors of the computing device 200 can retrieve and execute. For example, the memory devices can store a browser application 230 and/or an email application 220. It should be understood that the browser application 230 and/or the email application 220 can be executed by the same processor or by different processors included in the computing device 200 and/or can be executed by one or more processors external to the computing device 200.

The email application 220 manages email messages. In particular, the email application 220 allows a user to compose, address, and send email messages. The email application 220 can include a dedicated-use application or a general-purpose application. For example, as described above, a browser application can be operated as an email application and can receive an email web page over the network 400 that the user can use to compose, address, and send email messages. In these situations, when the browser application 230 is being used as an email application, the email application 220 and the browser application 230 may be the same application. As also noted above, however, the browser application 230 can also be used to access other resources connected to the network 400.

The memory devices of the computing device 200 can also store contact information, such as email addresses. For example, the computing device 200 can include an address memory 210 that stores contact information. The address memory 210 can be a special-purpose memory device or can be included as part of multi-purpose memory device. In some embodiments, the address memory 210 can be located external to the computing device 200. The address memory 210 stores contact information for various entities. For example, the address memory 210 can store email addresses, and the email application 220 can communicate with the address memory 210 in order to access an email address stored in the address memory 210 and populate the address line of an email message with the retrieved email address. The address line of an email message can include one or more recipient address fields, such as a “TO:” field, a “CC:” field, and/or a “BCC:” field, each of which is configured to receive an email address.

In some embodiments, the address memory 210 stores email addresses and names or other information related the entity or entities associated with each stored email address. To populate the address line of an email message using address memory 210, a user may enter addressee information, such as a portion of the addressee's name, into the address line of the email message, which can prompt the email application 220 to attempt to retrieve the addressee's email address from the address memory 210. Upon finding a match to the addressee information name entered by the user, the email application 220 can populate the address line of the email message with the matching email address. Alternately, the user can access a list of email addresses or addressees (e.g., names) stored in the memory address 210 and can select an address or an addressee from the list. The email application 220 can then populate the address line of the email address with the selected email address or the email address associated with the selected addressee.

The memory devices included in the computing device 200, including the address memory 210, can include any type of fixed and/or removable digital storage device and, if needed, a device for reading the digital storage device. For example, the memory devices and associated readers included in the computing device 200 can include floppy disks and floppy drives, CD-ROM disks and drives, optical disks and drives, hard-drives, RAM, ROM, and/or other such devices for storing and accessing digital information.

The email application 220 provides a user interface (e.g., a graphical user interface) to a user that allows the user to compose and send an email message. The user interface includes at least one message input mechanism (e.g., a text box, a selection mechanism for selecting a pre-established email message, etc.) that the user can use to compose an email message for an intended recipient. The email message can include textual objects, graphical objects, files, or any combination thereof. The user interface also includes an address line that includes a “TO:” field that the user can use to specify an email address of the addressee of the composed email message. In some embodiments, address line includes additional fields, such as a “CC:” field and/or a “BCC:” field. In some embodiments, as described below, the address line also includes additional fields that allow a user to input addressee information if the user does not know the email address associated with the addressee. In other embodiments, the user can use the “TO:” field and/or other standard fields included in the address line to specify addressee information, rather than using separately designated fields.

The email application 220 can be in communication with a mail server 310. When a user sends an email message using the email application 220, the email message is communicated to the mail server 310, which directs the email message to the addressee of the email message (e.g., via the network 400). Similarly, when an email message is sent to the user, the email message is received by the mail server 310 (e.g., via the network 400) and is communicated to the email application 220 operated by the user. In some embodiments, the mail server 310 sends and receives email messages according to the simple mail transfer protocol (“SMTP”) and the post office protocol (“POP”), respectively.

As shown in FIG. 1, the query interface 110 is in communication with the address subsystem 120 and the email application 220. As previously discussed, the email application 220 can communicate with the mail server 310 according to the SMTP and the POP protocols. However, the address subsystem 120 generally communicates with the network 400 through the address server 140 according to the hypertext mark-up language (“HTML”) protocol. Thus, the query interface 110 can be used to provide a link between the email application 220 and the address subsystem 120. For example, the query interface 110 can include an application programming interface (“API”), such as the ActiveX® programming architecture provided by the Microsoft® Corporation, which may perform several functions. For example, the query interface 110 can enable a user to form a query from within the email application 220 and can communicate the query to the address subsystem 120 (e.g., via the network 400). In another example, the query interface 110 can insert an email address provided from the address subsystem 120 into the address line of an email message being composed with the email application 220. In some embodiments, the query interface 110 can also distinguish between information received from the network 400 that is and is not intended for the email application 220 and can communicate the information to the intended application.

In some embodiments, if the email application 220 is a general-purpose application, such as the browser application 230, the email web page accessed by the browser application 230 can include instructions, such as an applet, that, when the web page is “executed” and displayed by the browser application 230, presents fields or prompts to a user (e.g., upon the occurrence of a triggering event) for specifying addressee information. The instructions included in the email web page can also forward addressee information specified by a user to the query interface 110. In addition, the instructions included in the email web page can display and/or incorporate information received from the address subsystem 120 (e.g., a query match) in the email web page. In some embodiments, the instructions included in the email web page also verify addressee information entered by a user (e.g., for format regulations, etc.) before sending the addressee information to the query interface 110.

By enabling a user to form a query within the email application 220 and by communicating the query to the address subsystem 120, the query interface 110 provides a way in which the user may search for a particular email address without leaving the email application 220. To enable the user to form a query from within the email application 220, the query interface 110 produces fields or prompts within the user interface provided by the email application 220. The fields provide areas for the user to provide addressee information, such as an addressee's name, occupation, physical mailing address, a company for which an addressee works, and/or other information that may be used to identify an addressee. In some embodiments, the query interface 110 formats the fields so that the user may enter the addressee information by typing the information into the fields and/or by selecting information from pull-down menus or other types of selection mechanisms. In addition, the query interface 110 may include a field or selection mechanism that enables the user to cancel a search. For example, a user can cancel a search by pressing a return button on a keyboard or by clicking on a “cancel” button or selection mechanism provided by the query interface 110. As noted above, in some embodiments, the user can use standard address line fields (e.g., the “TO:” field, the “CC:” field, the “BCC:” field, etc.) to specify addressee information, rather than using separately designated fields or prompts.

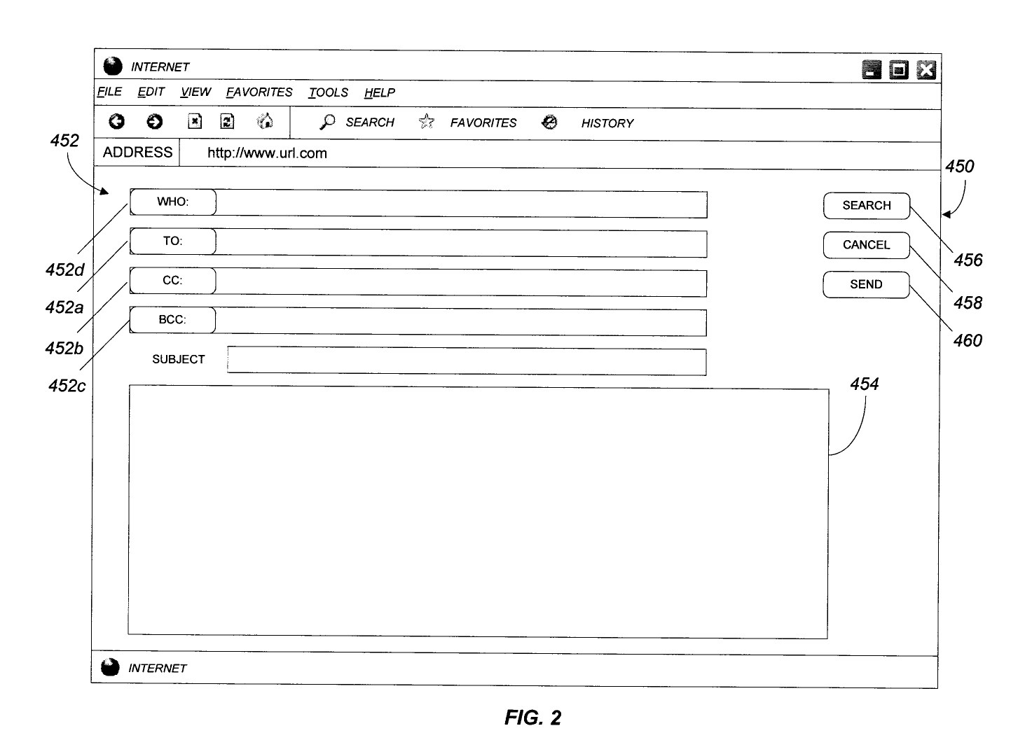

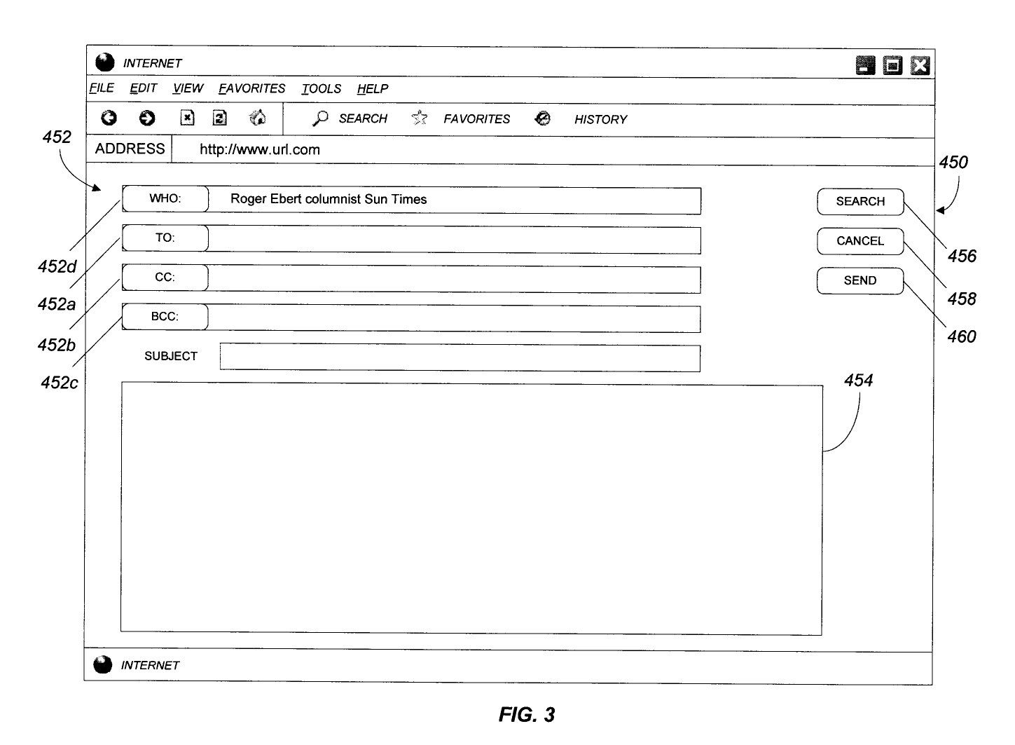

FIGS. 2-4 illustrate a user interface 450 provided by the email application 220 according to one embodiment of the invention. As shown in FIG. 2, the user interface 450 includes an address line 452 and a message input mechanism (e.g., a text box) 454. The user can use the message input mechanism to specify a message for one or more addressees and can use the address line 452 to enter one or more email addresses associated with the addressee(s). As shown in FIG. 2, the address line 452 can include one or more recipient address fields, such as a “TO:” field 452a, a “CC:” field 452b, and a “BCC:” field 452c. In some embodiments, the address line 452 also includes an addressee information field 452d (e.g., labeled “WHO:” in FIG. 3) that allows the user to enter addressee information (e.g., information other than an email address of the addressee). In some embodiments, the user interface 450 can display the addressee information field 452d in the address line 452 each time a user creates a new email message or responds to a previously received or existing email message. In other embodiments, the user interface 450 can include a selection mechanism that a user can select in order to display and/or hide the addressee information field 452d.

A user can use the addressee information field 452d to specify addressee information, such as an addressee's name, title or occupation, mailing address, etc. For example, as shown in FIG. 3, if a user is searching for Roger Ebert's email address, the user can enter the keywords “Robert,” “Ebert,” “columnist,” and “Sun Times” into the addressee information field 452d. As noted above, in some embodiments, the address line 452 does not include one or more specially-designated addressee information fields, and a user uses other fields included in the address line 452, such as the “TO:” field 452a, to specify addressee information.

In some embodiments, after a user enters addressee information into the addressee information field 452d (or other fields included in the address line 452) and moves to another field or portion of the user interface 450 (e.g., by pressing the enter or tab key on a keypad or keyboard of the computing device 200), the entered addressee information can be automatically obtained by the query interface 110 and used to generate a query for the address subsystem 120. In other embodiments, a user can manually submit entered addressee information to the query interface 110 and initiate a search by selecting a selection mechanism included in the user interface 450, such as a “SEARCH” selection mechanism 456. After the user selects the “SEARCH” selection mechanism, the query interface 110 generates a query based on the entered addressee information and submits the query to the address subsystem 120.

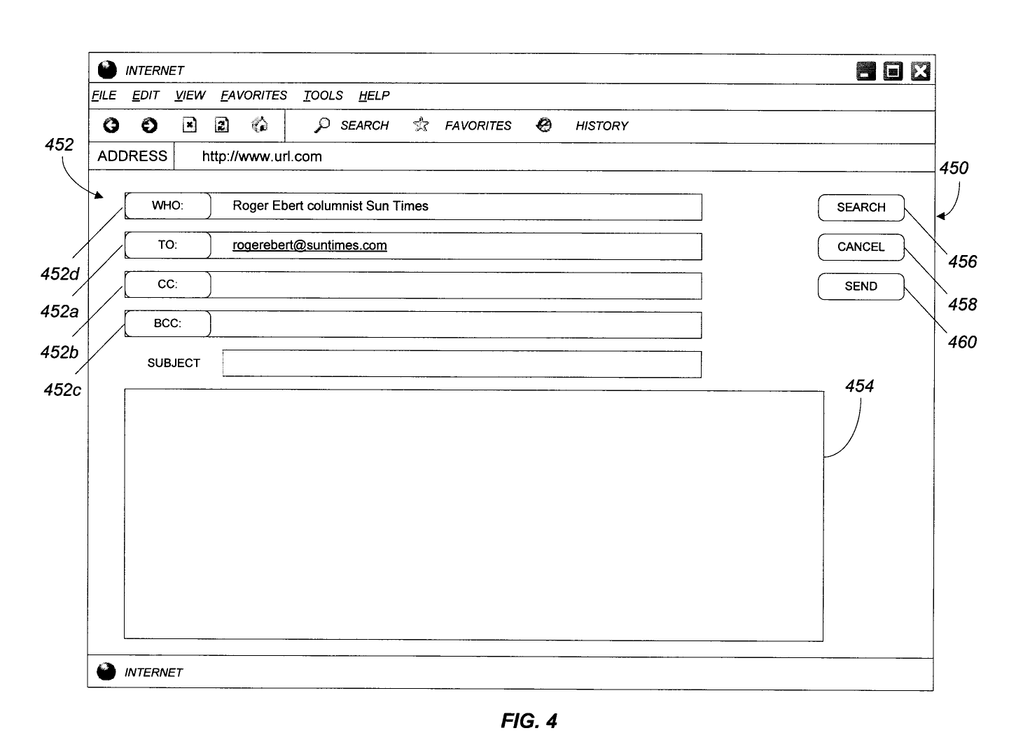

Upon receiving a response (e.g., a query match) from the address subsystem 120, the query interface 110 can automatically enter the returned email address into one or more recipient address fields of the address line 452 (e.g., the “TO:” field 452a, the “CC:” field 452b, and/or the “BCC:” field 452c). For example, as shown in FIG. 4, if a user had searched for Roger Ebert's email address and the address subsystem 120 was able to find Roger Ebert's email address (e.g., rogerebert@suntimes.com) in the address database 160, the query interface 110 automatically enters Roger Ebert's email address into the “TO:” field 452a.

As shown in FIGS. 2-4, the user interface 450 can also include a “CANCEL” selection mechanism 458 that a user can use to cancel an address search submitted to the query interface 110 (e.g., automatically or manually submitted). In some embodiments, selecting the “CANCEL” selection mechanism 458 can also hide the addressee information field 452d. The user interface 450 can also include a “SEND” selection mechanism 460 that a user can select in order to send an email message (specified in the message input mechanism 454) after the email message has been addressed (e.g., manually or as the result of querying the address subsystem 120).

Generally, the query interface 110 prompts the user for addressee information in response to one or more predetermined events that occur in connection with the operation of the email application 220. For example, the query interface 110 can prompt the user for addressee information when the user creates a new email message or forwards or responds to a received or existing email message. Alternately, the query interface 110 can prompt the user for addressee information when the user enters addressee information into the address line of an email message. In addition, when the user enters addressee information into the address line of an email message, the query interface 110 can prompt the user for addressee information if the email application 220 is unable to obtain an email address associated with the entered addressee information from the address memory 210.

The query interface 110 can also be in communication with the browser application 230. As previously described, in some embodiments, the browser application 230 enables a user to “surf” the Internet by requesting web pages from one or more external servers via a network, such as the Internet, according to the HTML protocol and by displaying returned web pages to the user. Thus, in some embodiments, the query interface 110 receives HTML signals related to the requesting, displaying, and/or navigating of web pages associated with the browser application 230 and also receives HTML signals from the address subsystem 120 intended for the email application 220. To distinguish these signals from each other, the query interface 110 can check an address included in an incoming signal. If a signal includes an address associated with the address subsystem 120, the query interface 110 recognizes the signal as relating to a search of the address database 160, and, therefore, determines that the signal is associated with the email application 220. However, if the signal does not include an address associated with the address subsystem 120, the query interface 110 can determine that the signal is intended for another application (e.g., the browser application 230) and can communicate the signal to intended receiving application. Similarly, if the query interface 110 receives signals from another application, such as the browser application 230, that are not destined for the address subsystem 120, the query interface 110 can communicate the signals to the server or other computing device (e.g., via the network 400) indicated by the address specified in the signals received from the application.

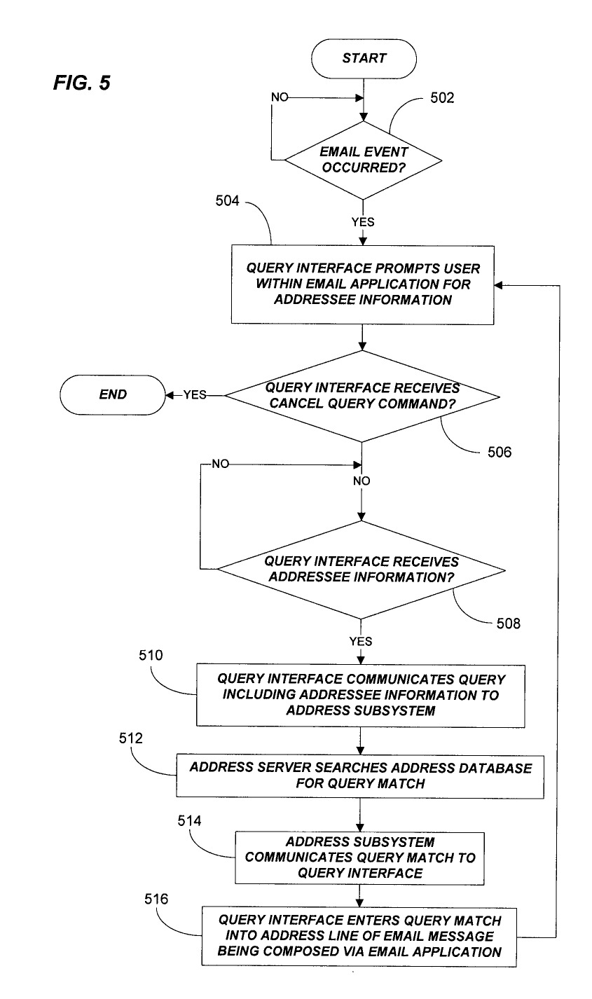

FIG. 5 illustrates a method 500 of retrieving an address from the address subsystem 120 according to one embodiment of the invention. The method 500 will be described with reference to FIGS. 1 and 5. In step 502 of the method 500, the query interface 110 monitors the email application 220 for an event to occur. When an event occurs, such as the creation of a new email message or the entering of addressee information into the address line of an email message, the query interface 110 can display one or more fields or prompts within the email application 220 (e.g., the user interface generated by the email application 220). The user of the email application 220 uses the prompts to specify addressee information, such as the addressee's name, title or occupation, mailing address, etc., that will be used to query the address subsystem 120 for an email address associated with the intended addressee of the email message (step 504). Alternately, if the user does not wish or need to perform an email address search, the user can cancel the query in step 506 by performing one or more actions, such as by clicking on a “cancel” field or by pressing a key on a keyboard or keypad of the computing device 200 (e.g., the return key or the escape key). In some embodiments, the prompts displayed by the query interface 110 can inform the user of how to cancel a search. If the user cancels the query, the prompts can disappear, and the user can continue to use the email application 220.

If the user does not cancel the query, the query interface 110 waits for the user to enter and submit addressee information (step 508). Using the example described above, if the user is composing an email message for Roger Ebert, the well-known columnist for the Sun Times, the user can use one or more of the prompts provided by the query interface 110 to enter the terms or keywords “Roger,” “Ebert,” “columnist,” “Sun Times,” and/or any combination or variation thereof. In some embodiments, one or more of the prompts provided by the query interface 110 specify particular addressee information to be entered. For example, the query interface 110 can display one prompt that instructs the user to enter a name of the addressee (e.g., first name and/or last name). The query interface 110 can also display another prompt that instructs the user to enter a title or occupation of the addressee. In other embodiments, the query interface 110 can provide one or more general-purpose prompts that allow a user to enter any desired keywords. If using a general-purpose prompt, the user can use identifiers to associate a keyword with a particular characteristic of an addressee. For example, if the user enters a keyword associated with an addressee's name, the user can enter an identifier, such as “NAME:,” “<NAME>,” “/NAME,” “NAME/,” etc., prior to or after entering the keyword.

In some embodiments, the query interface 110 can permit a user to enter wildcards or Boolean expressions into the prompts. For example, if a user is unsure of the addressee's title or the spelling of the addressee's name, the user can enter the known portion of the addressee information and can use a wildcard or a Boolean expression for the unknown portion of the addressee information. In some embodiments, the query interface 110 and/or the prompts can verify that information entered by a user conforms to any formatting, length, etc. recommendations or requirements.

After entering addressee information, the user submits the information to the query interface 110. In some embodiments, the user submits addressee information to the query interface 110 by, for example, clicking on a “send” field or selection mechanism or by pressing the return or tab key on a keyboard or keypad of the computing device 200. After receiving the addressee information, the query interface 110 formats the addressee information into a query and communicates the query to the address subsystem 120 (e.g., via the network 400) (step 510). In some embodiments, the query interface 110 formats the address information into a query that complies with the HTML protocol.

The address server 140 of the address subsystem 120 receives the query from the query server 110 (e.g., via the network 400). In some embodiments, if the address subsystem 120 includes a security device, such as the firewall 130, the security device receives the query and communicates the query to the address server 140 (e.g., after verifying the source or contents of the query). The address server 140 incorporates the addressee information included in the received query into a search routine that, when executed, searches the address database 160 for one or more email addresses that correspond (e.g., approximately) with the addressee information included in the query (step 512). In particular, the search routine attempts to find one or more email addresses stored in the address database 160 that are associated with identifying information (also stored in the address database 160) that matches (e.g., approximately) the addressee information included in the query.

If the search routine finds a match to the addressee information included in the query (i.e., “a query match”), the address server 140 communicates the query match to the email application 220 through the query interface 110 (step 514). In some embodiments, the query match can be formatted as a signal that complies with the HTML protocol.

When the query interface 110 receives the query match, the query interface 110 can examine the signal to determine if the signal is intended for the email application 220 or another application (e.g., the browser application 230). For example, as noted above, the query interface 110 can examine an address, or other identifier, included in the signal. If the address included in the signal corresponds to an address associated with the address subsystem 120, the query interface 110 determines that the signal is intended for the email application 220 and examines the signal to decipher the information included in the signal. In some embodiments, the query interface 110 recognizes a query match included in the signal (e.g., the format of results provided from the address subsystem 120) and determines that the signal is intended for the email application 220.

After identifying that a signal is intended for the email application 220, the query interface 110 isolates the query match included in the signal and inserts the query match into an address line of an email message being manipulated by the email application 220 (step 516). In some embodiments, before the query interface 110 inserts the query match into the address line of an email message, the query interface 110 provides one or more fields in the email application 220 asking the user to confirm that the query match is indeed the email address of the entity that the user was searching for (i.e., is a correct query match). If the user indicates that the query match is a correct query match, for example, by clicking on a particular field presented by the query interface 110, the query interface 110 inserts the query match into the address line of the email message. However, if the user indicates that the query match is not a correct match, the query interface 110 does not insert the query match into the address line of the email and, in some embodiments, provides one or more prompts in the email application 220 that enable the user to revise the previous query and/or begin a new query.

The address server 140 may find multiple query matches during a search of the address database 160. In this case, the address server 140 can communicate the multiple query matches to the query interface 110 in the manner described above. However, when the query interface 110 examines the signal and recognizes that the signal includes multiple query matches, the query interface 110 can present the multiple query matches in the email application 220 (e.g., the user interface) so that the user can select a correct query match. For example, the query interface 110 can present the multiple query matches in a table, a pull-down menu, or other format that enables the user to select a correct query match. When the user selects a correct query match, the query interface 110 inserts the selected match into the address line of the email message. In addition to the fields in which the multiple query matches are indicated, the query interface 110 can include a field that allows the user to indicate that none of the query matches are a correct match. If the user selects this field, the query interface 110 does not insert a query match into the address line of the email message and, in some embodiments, provides one or more prompts that enable the user to revise the previous query and/or begin a new query.

If the address server 140 does not find any query matches in the address database 160, the address server 140 communicates a signal to the query interface 110 indicating this fact. When the query interface 110 examines the signal, the query interface 110 determines that no query matches are included in the signal, communicates with the email application 220 that no query matches were found, and, consequently, does not insert a query match into the address line of an email message. In addition, the query interface 110 can prompt the user to revise the previous query and/or begin a new query.

While various embodiments of the invention have been described, it will be apparent to those of ordinary skill in the art that many more embodiments and implementations are possible within the scope of the invention.

Various features of embodiments of the invention are set forth in the following claims.

1. A method of obtaining an email address, the method comprising:
automatically compiling email address information and corresponding identifying information for a plurality of well-known entities from at least one data source;
creating an address subsystem including an address database based on the email address information and the corresponding identifying information;
providing a user interface, via an email application, the user interface including an address line and a message input mechanism for entering an email message;
receiving addressee information from a user via the user interface, the addressee information not including an email address;
generating a query based on the addressee information;
sending the query to an address subsystem over at least one computer network;
receiving at least one match from the address subsystem, the at least one match including an email address; and
automatically entering the email address into the address line of the user interface.

2. The method of claim 1, wherein automatically compiling email address information and corresponding identifying information for a plurality of well-known entities from at least one data source includes compiling email address information and corresponding identifying information from at least one data source accessible over a computer network.

3. The method of claim 1, wherein receiving addressee information from a user via the user interface includes receiving addressee information from a user via at least one field included in the user interface.

4. The method of claim 3, wherein receiving addressee information from a user via at least one field included in the user interface includes receiving addressee information from a user via at least one recipient address field included in the address line.

5. The method of claim 3, wherein receiving addressee information from a user via at least one field included in the user interface includes receiving addressee information from a user via at least one addressee information field included in the address line.

6. The method of claim 1, wherein generating a query based on the addressee information including generating a query according to the hypertext mark-up language protocol.

7. The method of claim 1, further comprising repeatedly compiling email address information and corresponding identifying information for a plurality of well-known entities from at least one data source.

8. A system for obtaining an email address, the system comprising:
an address database configured to store email address information and corresponding identifying information for a plurality of well-known entities;
an email application configured to generate a user interface, the user interface including an address line and a message input mechanism for entering an email message;
a query interface configured to obtain addressee information entered by the user via the user interface, to generate a query based on the addressee information, and to transmit the query to an address subsystem over at least one communication link, the addressee information not including an email address; and
the address subsystem configured to receive the query, to search the address database based on the query, and to transmit at least one match to the query interface, the at least one match including an email address;
the email application configured to automatically include the email address in the address line of the user interface.

9. The system of claim 8, wherein the corresponding identifying information includes at least one of a name, a title, an occupation, and a mailing address.

10. The system of claim 8, wherein the email application includes a dedicated-use application.

11. The system of claim 8, wherein the email application includes a multiple-purpose application.

12. The system of claim 8, wherein the email application includes a browser application.

13. The system of claim 8, wherein the address line includes at least one recipient address field.

14. The system of claim 13, wherein the query interface is configured to obtain addressee information entered by the user via the at least one recipient address field.

15. The system of claim 8, wherein the address line includes at least one recipient address field and at least one addressee information field.

16. The system of claim 15, wherein the query interface is configured to obtain addressee information entered by the user via the at least one addressee information field.

17. The system of claim 8, wherein the email application is configured to display the email address and prompt the user to confirm the email address.

18. A computer-readable medium encoded with a plurality of processor-executable instructions for obtaining an email address, the instructions comprising
providing a user interface including an address line and a message input mechanism for entering an email message, the address line including a recipient address field and an addressee information field;
receiving addressee information from a user via the addressee information field, the addressee information not including an email address;
generating a query based on the addressee information;
sending the query to an address subsystem over at least one communication link;
receiving at least one match from the address subsystem, the at least one match including an email address; and
automatically entering the email address into the recipient address field.

19. The computer-readable medium of claim 18, further comprising instructions for displaying the email address to the user and prompting the user to confirm the email address prior to automatically entering the email address into the recipient address field.

20. The computer-readable medium of claim 18, further comprising instructions for displaying a plurality of email addresses to the user and prompting the user to select one of the plurality of email addresses.
